(19) United States
(12) Patent Application Publication
(10) Pub. No.: US 2007/0271127 A1
(43) Pub. Date: Nov. 22, 2007

(54) Database driven subrogation claim management system

(76) Inventors: Peter Tassock Marks, Portland, OR (US); David Madden, Tempe, AZ (US)

Correspondence Address: KOLISCH HARTWELL, P.C., 200 PACIFIC BUILDING, 520 SW YAMHILL STREET, PORTLAND, OR, 97204, US

(21) Appl. No.: 11/383,934

(22) Filed: May 17, 2006

(51) Int. Cl. G06Q 10/00

(52) U.S. Cl. 705/8

(57) ABSTRACT

A technique to automate legal aspects of the automotive insurance subrogation recovery processes using a computerized database system is enclosed. This technique includes storing standardized data such as court and insurance company information and claim specific data such as claimant and insured party information in an organized database. A computer then interprets these two kinds of data in the context of applicable legal statutes and schedules events to further the recovery of the claim. Scheduled events then trigger the program to automatically generate legal and correspondence documents using information stored in the database. The program also creates specialized web pages for a variety of users. These pages display necessary information for the user using information held in the database.

### BACKGROUND INFORMATION

It is common practice for insurance companies to reimburse clients from damages incurred in an automobile accident. Should another party be liable in any way for the accident, the insurance company is by law given the right to collect from that party. This action is commonly referred to as a subrogation claim. Oftentimes it is difficult to collect from these parties (commonly referred to as claimants), especially if they are uninsured. Under these circumstances insurance companies often seek legal representation to assist in the recovery of these claims. The standard practice for this recovery process for an attorney or law firm involves storing all information in a paper file system, manually calendaring all claim related events and manually composing necessary court forms and correspondence.

### DESCRIPTION

This invention is a computerized database system that automates many legal aspects of the automotive insurance subrogation recovery processes.

### REFERENCES CITED

U.S. PATENT DOCUMENTS:

| | | |
|---|---|---|
| 4837693 | June, 1989 | Schotz. |
| 5043891 | August, 1991 | Goldstein et al. |
| 5175681 | December, 1992 | Iwai et al. |
| 5191522 | March, 1993 | Bosco et al. |
| 5267155 | November, 1993 | Buchanan et al. |
| 5329447 | July, 1994 | Leedom, Jr. |
| 5444615 | August, 1995 | Bennett et al. |
| 5583778 | December, 1996 | Wind |
| 5956687 | September, 1999 | Wamsley et al. |
| 5991733 | November, 1999 | Aleia et al. |

What is claimed is:

1. A method, comprising:
Executing a computer program to enter two kinds of data into an organized database: Standardized data and claim specific data;
Standardized data consists of names, contact information, policies and fees for organizations such as courts, sheriff's offices, insurance companies, process servers and attorneys;
claim specific data consists of information unique to a claim such as claimant and insured party information, accident details and a breakdown of damages. It also consists of references to standardized data (such as the insurance company making the claim or the court that would have jurisdiction in a subsequent lawsuit);

2. A method, comprising:
Executing a computer program to interpret these two types of data in the context of applicable legal statutes and schedule events to further the recovery of the claim;
These events prompt the automatic generation of the following legal and correspondence documents using the information stored in the database;
1. Correspondence with insurance companies regarding the assigned claim
2. Correspondence with insured parties regarding accident information
3. Correspondence with claimant regarding satisfaction of the claim
4. Correspondence with sheriff's offices or process servers to request the service of legal documents
5. Court documents necessary for filing a lawsuit and obtaining a judgment including:
a. Summons
b. Complaint
c. Stipulated judgment agreement
d. Declarations for insured parties and insurance companies
e. Default motion and affidavit
f. Entry of judgment
6. Department of Motor Vehicles forms for license suspension
7. Forms for the garnishment of wages, businesses and bank accounts
Once the document is sent the program awaits input from the recipient. Once the input has been received or a specified time period has expired, the program reinterprets the claim. It then schedules another event and prints a corresponding document. The cycle is repeated until the full amount of the claim has been collected or until it is impossible to take any further action to collect;

3. A method, comprising:
Executing a computer program to interpret claim data and display it in a clear and readable manner on a secure webpage;
Log in names and passwords allow users to access such webpages. The following are the types of users and the privileges they are given:
1. Insurance company administrators: Access to all of their company's claims and the ability to assign claims to insurance adjusters
2. Insurance adjusters: Access to the claims they have been assigned them to manage
3. Attorneys: Access to all claims they have been assigned by the insurance company to represent and the ability to enter in new cases.
4. Claimants: Access to the claim they are involved in and the ability to make online payments
5. Administrators: Access and full privileges for every claim in the system as well as all standardized data.
The webpage can be used both to view and to edit claim data;
